(19) United States
(12) Patent Application Publication
(10) Pub. No.: US 2023/0289507 A1
(43) Pub. Date: Sep. 14, 2023

(54) ANALYZING INTEGRATED CIRCUIT TIMING VARIATION

(71) Applicant: NVIDIA Corporation, Santa Clara, CA (US)

(72) Inventors: Chunhui Li, Mountain View, CA (US); Sreedhar Pratty, Campbell, CA (US); Tezaswi Raja, San Jose, CA (US); Wen Yueh, San Jose, CA (US); Vinayak Bhargav Srinath, San Jose, CA (US)

(21) Appl. No.: 17/693,122

(22) Filed: Mar. 11, 2022

(51) Int. Cl. G06F 30/367

(52) U.S. Cl. CPC G06F 30/367; G06F 2119/12

(57) ABSTRACT

During a testing of a circuit design, an adaptive clock model and a voltage noise model are utilized within the computer implemented method of the testing environment in order to determine the dynamic effects of voltage variation and adaptive clock on the timing of the circuit design. The computer implemented method uses a hybrid stage that incorporates both a graph-based approach and a path-based approach may also be incorporated into the testing environment in order to maximize a performance of the testing of the circuit design.

### FIELD OF THE INVENTION

The present invention relates to circuit design and implementation, and more particularly to analyzing a timing of a circuit design.

### BACKGROUND

Analyzing the timing of an integrated circuit design is essential for the proper functioning of an integrated circuit constructed based on the design. However, current methods for determining timing suffer from either deficient accuracy or performance. Current static timing analysis methods have high performance when analyzing an entire chip but sacrifice accuracy with simplified static models that lose the dynamic effects of noise and adaptive clock. Current dynamic analysis methods such as spice have accurate dynamic noise and clock models, but with very limited performance. These methods are only practical when analyzing a small set of selected paths that only represent a small portion of the design, which creates a risk of over-generalization when used to sign off an entire chip design. What is needed is a high-performance method that has the capacity to practically perform entire chip timing variation analysis without sacrificing accurate dynamic effects of noise and adaptive clock models.

### BRIEF DESCRIPTION OF THE DRAWINGS

FIG. 1 illustrates a flowchart of a method for performing circuit testing while considering voltage noise, in accordance with an embodiment.

FIG. 2 illustrates a flowchart of a method for performing circuit testing using a hybrid approach, in accordance with an embodiment.

FIG. 3 illustrates an exemplary dynamic testing environment, in accordance with an embodiment.

FIG. 4 illustrates an exemplary system in which the various architecture and/or functionality of the various previous embodiments may be implemented.

FIG. 5 is a block diagram illustrating a computer system configured to implement one or more aspects of the various embodiments.

### DETAILED DESCRIPTION

During a testing of a circuit design, an adaptive clock model and a voltage noise model are utilized within the computer implemented method for the testing environment in order to determine the dynamic effects of voltage variation and noise-aware adaptive clock on the timing of the circuit design. In the computer-implemented method, a hybrid stage that incorporates both a graph-based approach and a path-based approach may also be incorporated into the testing environment in order to maximize a performance of the testing of the circuit design.

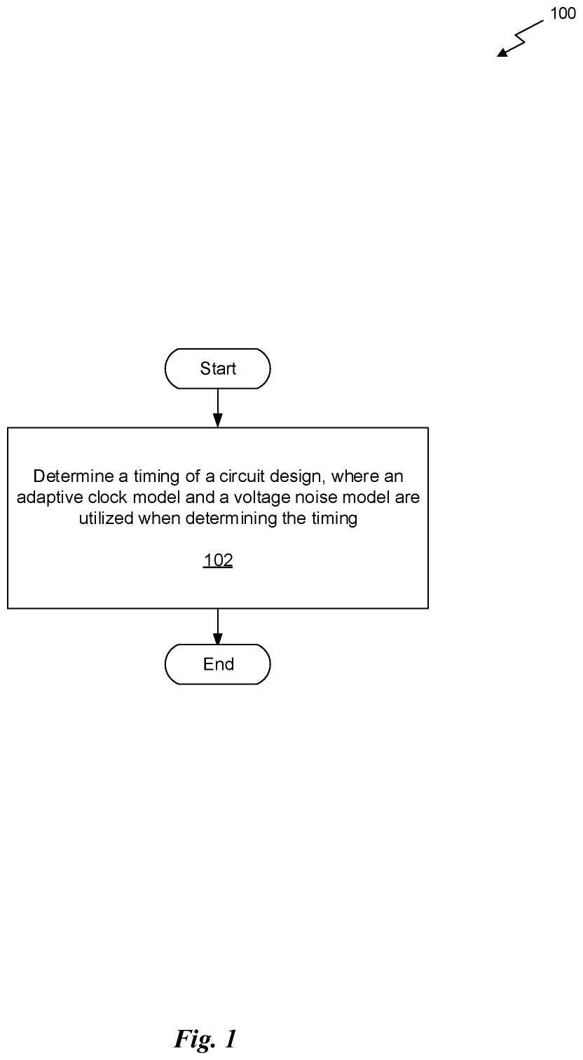

FIG. 1 illustrates a flowchart of a method 100 for performing circuit testing while considering voltage noise, in accordance with an embodiment. Although method 100 is described in the context of a processing unit, the method 100 may also be performed by a program, custom circuitry, or by a combination of custom circuitry and a program. For example, the method 100 may be executed by a GPU (graphics processing unit), CPU (central processing unit), or any processing element. Furthermore, persons of ordinary skill in the art will understand that any system that performs method 100 is within the scope and spirit of embodiments of the present invention.

As shown in operation 102, a timing of a circuit design is determined, where an adaptive clock model and a voltage noise model are utilized when determining the timing. In one embodiment, the circuit design may include a design for a digital integrated circuit. For example, the digital integrated circuit may include a microprocessor.

Additionally, in one embodiment, the timing of the circuit design may be determined during a testing of a circuit design (e.g., an analysis of a performance of the circuit design) in a simulated environment such as a testing module. For example, within the simulated environment, power may be supplied to the circuit design, and the timing of the circuit design may be determined in response to supplying the power.

Further, in one embodiment, determining the timing of the circuit design may include measuring a delay within the circuit design at one or more steps after power is supplied to the circuit design. In another embodiment, utilizing the adaptive clock model may include using a previous cycle supply noise. For example, during each clock cycle while testing of the circuit design, a previous cycle supply noise may be identified. In another example, this supply noise may be used during the testing to dynamically determine a period of the cycle and to determine a cycle start time (e.g., at a clock generator root pin of the circuit design).

Further still, in one embodiment, the voltage noise model may include original supply noise waveforms for one or more power supplies. For example, the waveforms may be produced by physical voltage supplies (e.g., power supplies). In another example, the waveforms may be used instead of a fixed voltage during the testing (e.g., when determining the timing of the circuit design). In another embodiment, when gate delays are calculated during timing testing, the waveforms may be checked to determine a real operational voltage of a gate (e.g., at a time when the signal arrives at a gate input pin).

Also, in one embodiment, utilizing the voltage noise model, three voltage corners surrounding the real operational voltage may be determined. For example, three gate delays may be determined at those voltage corners. In another example, quadratic interpolation may be applied to these gate delays to determine the real gate delay for the circuit design at a given voltage.

In addition, in one embodiment, the circuit design may be adjusted, based on the determined timing. For example, after testing is performed, the circuit design may be adjusted to change a timing of the circuit design. In another embodiment, a hardware circuit may be constructed based on the circuit design.

In this way, the dynamic effects of voltage variation and power supply noise on circuit design timing may be determined during testing of the circuit design. This may result in a more accurate timing determination for the circuit design during testing, which may improve a performance of a resulting circuit that is constructed utilizing the circuit design.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

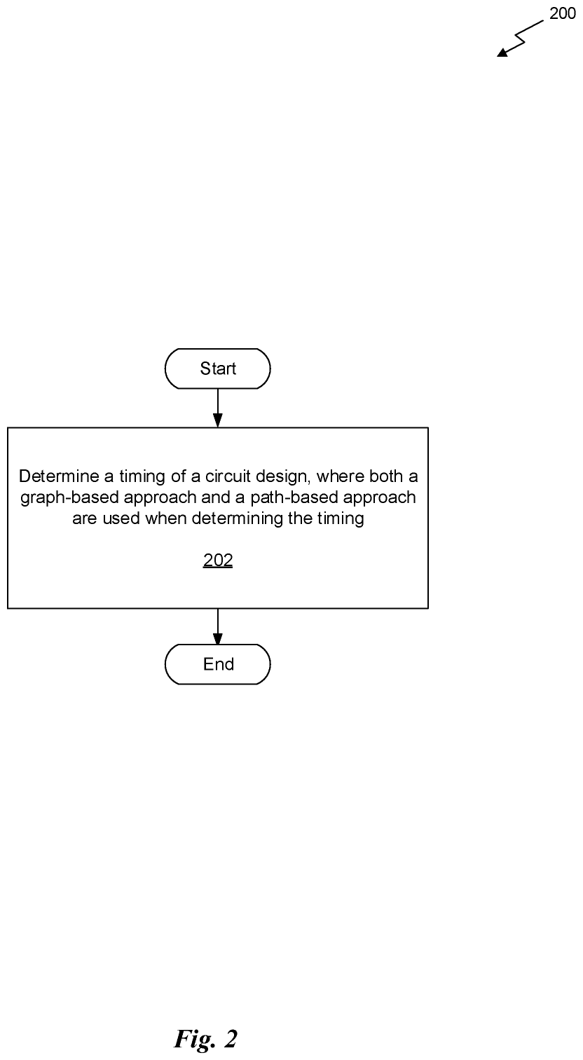

FIG. 2 illustrates a flowchart of a method 200 for performing circuit testing using a hybrid approach, in accordance with an embodiment. Although method 200 is described in the context of a processing unit, the method 200 may also be performed by a program, custom circuitry, or by a combination of custom circuitry and a program. For example, the method 200 may be executed by a GPU (graphics processing unit), CPU (central processing unit), or any processing element. Furthermore, persons of ordinary skill in the art will understand that any system that performs method 200 is within the scope and spirit of embodiments of the present invention.

As shown in operation 202, a timing of a circuit design is determined, where both a graph-based approach and a path-based approach are used when determining the timing. In one embodiment, the circuit design may include a design for a digital integrated circuit. For example, the digital integrated circuit may include a microprocessor.

Additionally, in one embodiment, the timing of the circuit design may be determined during a testing of a circuit design (e.g., an analysis of a performance of the circuit design) in a simulated environment such as a testing module. For example, within the simulated environment, power may be supplied to the circuit design, and the timing of the circuit design may be determined in response to supplying the power. In another embodiment, determining the timing of the circuit design may include measuring a delay within the circuit design at one or more steps after power is supplied to the circuit design.

Further, in one embodiment, a hybrid stage including both the graph-based approach and the path-based approach may be used to determine the timing of the circuit design. For example, the hybrid stage includes a calculation of delay within the circuit design. In another example, the hybrid stage includes a driving cell, an RC network of a net at an output of the cell, a capacitive load of network load pins within the circuit design, and a path, cycle and logic-uniquified input signal.

Further still, in one embodiment, utilizing the graph-based approach, a directed acyclic graph (DAG) may be constructed for the circuit design, where the DAG represents all paths within the circuit design. In another embodiment, during an analysis of the circuit design, each gate in the DAG may be visited only once. In yet another embodiment, utilizing the path-based approach, all delay calculations from all paths and cycles within the circuit design that are related to a gate may be performed during a single visit to the gate and may be propagated throughout the rest of the circuit design.

Also, in one embodiment, the hybrid stage may simulate the circuit design, where the simulation is divided into an input-dependent portion and an input-independent portion. For example, the input-independent portion may be calculated once for all possible scenarios within the circuit design. In another embodiment, logic-identical input delays may be shared among different paths during the testing of the circuit design. In yet another embodiment, delay and noise values that are identical or have a difference within a predetermined threshold value may be shared among different paths, waveforms, and scenarios within the circuit design.

The hybrid stage enables high computational locality. The detailed RC network and driver and load model information for a gate is stored, accessed, and then released once, and is used for computing all scenarios related with the gate. Therefore, such information enables the implementation of a highly scalable parallelism algorithm while maintaining low peak memory usage for computing.

For the input-dependent portion of the analysis, the path, cycle and logic uniquified input signal information in the hybrid stage is incorporated to preserve the dynamic effects of noise and adaptive clock models.

In addition, in one embodiment, the circuit design may be adjusted, based on the determined timing. For example, after testing is performed, the circuit design may be adjusted to change a timing of the circuit design. In another embodiment, a hardware circuit may be constructed based on the circuit design.

In this way, by implementing the hybrid stage during testing of a circuit design, a high-performance dynamic analysis of the whole chip may be performed without losing the accurate dynamic effects of noise and the adaptive clock models. This may improve an accuracy of the testing while also reducing an amount of time taken to perform the testing, which may reduce an amount of power needed by testing hardware to perform such testing, which may in turn improve a performance of the testing hardware.

### Exemplary Testing Environment

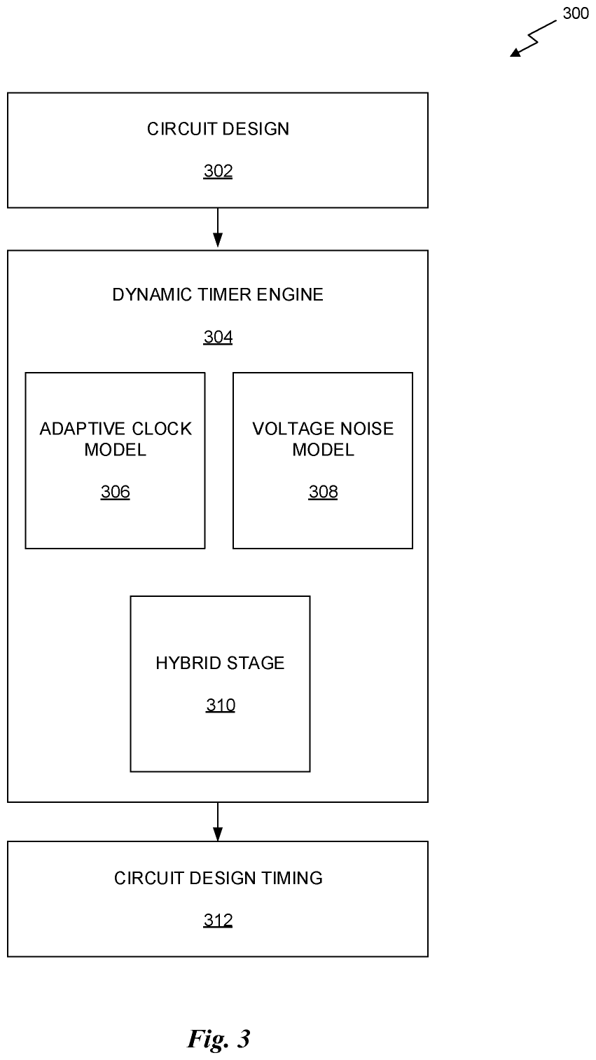

FIG. 3 illustrates an exemplary dynamic testing environment 300, according to one exemplary embodiment. As shown, a circuit design 302 is input into a dynamic timer engine 304. The dynamic timer engine 304 performs an analysis of the circuit design 302 utilizing an adaptive clock model 306, a voltage noise model 308, and a hybrid stage 310 to determine a timing 312 of the circuit design 302.

By implementing the hybrid stage 310 during testing of the circuit design 302, a dynamic analysis of the circuit design 302 may be performed while maximizing a performance of the testing. The adaptive clock model 306 and voltage noise model 308 may account for the dynamic effects of voltage variation on the timing 312 of the circuit design 302 during testing of the circuit design 302. This may improve an accuracy of the testing while also reducing an amount of time taken to perform the testing, which may reduce an amount of power needed by testing hardware to perform such testing, which may in turn improve a performance of the testing hardware.

### High-Performance Dynamic Analysis of Integrated Circuit Timing Variations with Supply Noise and Adaptive Clock

Efficiently modeling and analyzing the effect of supply noise on chip timing variation important but also challenging. With designs reaching 5 nm and below for technology nodes, and operations performing at near-threshold levels, voltage variation in delay is becoming larger than nominal delay at lower voltages. This impacts circuit yield as well as power usage, performance, and design area, and it is therefore important to determine the impact of supply noise on timing.

However, supply noise varies at a cell level both spatially across a design and temporally during signal propagation along paths. As a result, it is challenging to incorporate supply noise into traditional static timing analysis (STA). On the other hand, dynamic simulations such as spice are known to be limited by performance and capacity. This challenge is exacerbated by more complex models with voltage noise adaptive clocks and increasing chip sizes and design complexity.

One method of analyzing a circuit design is using voltage drop aware static timing analysis (IR-STA). In order to fit into this static analysis framework, the analysis assumes the worst voltage drop occurs simultaneously at all cells and uses this to find the worst path due to voltage noise. Since this assumption is not true, results show no correlation with silicon. The results are often over-pessimistic that can result in overdesign of the chip; and the results may also be optimistic while capture clock calculation may be more pessimistic than a launch clock under a worst voltage drop assumption—this may put the yield and first working silicon at risk.

Another static timing analysis method applies margins, scaling and statistical modeling, which can predict nominal behavior, but not variation. This is because the method heavily depends on statistical cancellation of miscorrelation that cannot capture design anomalies on silicon tail performance caused by dynamically varied supply noise.

Since the above methods are not sufficient to analyze dynamic effects of voltage variation on timing, spice simulation may be used. However, spice may have limited performance and capacity during testing. This method is practical when applied on a few sample paths, but it lacks the capability to cover an entire circuit design with millions of paths as well as numerous waveforms and scenarios.

Overview

In one embodiment, an adaptive clock model and voltage noise model (utilizing both low frequency and high frequency noise waveforms) may be integrated inside a dynamic timer engine, and a novel algorithm may be applied that combines a graph-based analysis (GBA) method with a path-based analysis (PBA) method to perform true dynamic analysis on each path and each cycle of a circuit design with an efficiency as high as STA-GBA and an accuracy in bound with spice simulation.

Clock Model

In one embodiment, an adaptive clock model is included in a dynamic timer engine. For each cycle, based on previous cycle(s) supply noise, the model may dynamically calculate the period and decide the cycle start time at the clock generator root pin. This solution may handle both a fixed period clock and an adaptive clock, which enables the analysis of what remains of supply noise that cannot be fully compensated by an adaptive clock and that needs to be margined or optimized.

Supply Noise

In one embodiment, instead of using a simplified model such as IR-STA or other statistic models, real original supply noise waveforms are loaded into the testing environment. When calculating each gate delay, the environment may dynamically check these waveforms to get a real operational voltage of a gate at the time when the signal arrives at the gate input pin. Also, three pre-characterized voltage corners surrounding the real operational voltage may be determined, and three gate delays may be calculated at those voltage corners. Quadratic interpolation may then be applied to get a real gate delay at any real voltage.

Hybrid Algorithm

In one embodiment, a GBA-PBA hybrid algorithm may be implemented within the testing environment. The GBA algorithm builds a directed acyclic graph to represent all the timing paths in the design. The cells are converted to nodes and the wires are represented as directed arrows that connect nodes. When multiple inputs cells' arcs merge at the output, only the worst case is kept. In this way each cell in the graph is visited and calculated only once, resulting in a high performance. But during arc merging, the path specific timing information may be lost, results may be pessimistic and not suitable for dynamic voltage variation analysis where each cell delay can be different per cycle per path.

On the other hand, the PBA algorithm calculates and propagates a delay for each path. Each cell's delay is calculated using a path-specific input transition. The GBA pessimism is resolved due to arc merging, but this implementation is slower than GBA because there is no sharing between paths. For a dynamic voltage variation timing analysis, each cell delay is not only path-specific but also cycle specific, so arc cannot be merged as in GBA. Additionally, the computation complexity is a magnitude higher than PBA, so higher performance is necessary. As a result, a unique data structure called hybrid stage is created to represent the gate arc with its delay. Unlike the path-specific stage in path-based analysis (PBA) which has no sharing for common cells through different paths, or the cell-specific stage in graph-based analysis (GBA) that lose the timing difference per different cycles/paths, the hybrid stage may be delay-specific, and may keep all unique up-stream delays. For a high-fanout clock tree which has only one unique delay, the hybrid model may identify and maximize real sharing in the circuit; for a high-fanin data path, the different delays from different up-stream paths are identified and compressed without losing accuracy.

To implement this hybrid stage, a directed acyclic graph is constructed to represent all paths of a circuit, and each gate in the graph is visited only once, where all the delay calculations from all paths and cycles related with this gate are done in that one visit and are propagated. This localization strategy is highly efficient for parallelism. The GBA-PBA hybrid algorithm can therefore perform much faster than a spice simulation.

Benefits

Unlike an STA implementation that only can handle a fixed period clock, an adaptive clock model is integrated into the dynamic timing engine. Unlike an IR-STA implementation that uses the worst-case voltage, a real noise waveform is used the real-time gate voltage is dynamically determined for each gate delay calculation and is propagated. While an STA implementation cannot capture silicon anomalies, the above solution performs truly dynamic analysis.

Unlike a spice simulation that simulates one or a few paths, the above solution provides a GBA-PBA hybrid algorithm which utilizes an efficient GBA graph algorithm without losing path/cycle specific information during merge timing arcs, which allows the efficient storage, propagation, and tracing back of all dynamic information.

In one embodiment, a testing solution may use a modeling of dynamic supply noise and adaptive clock (e.g., an ACTIVE flow), which may be implemented in C++ and integrated into a high-performance C++ timing engine. A GBA-PBA hybrid algorithm may be implemented which can achieve results faster than a spice simulation, and therefore has the capability to cover an entire circuit design with millions of paths, numerous waveforms and scenarios, and analysis variations with Monte Carlo analysis.

In one embodiment, the GBA-PBA hybrid algorithm may implement a new delay-specific hybrid timing stage, which enables the performance of all calculations (such as all paths, noise waveforms, and scenarios) related with that one stage in one visit. At the stage level, this hybrid stage enables three techniques to achieve high performance:
1) separating the stage simulation into an input-dependent portion and an input-independent portion, where the input-independent portion is calculated once for all scenarios.
2) sharing the same logic-identical input delay among different paths.
3) sharing the same or similar delay and noise values among different paths, waveforms, and scenarios.

Unlike a PBA path-by-path simulation, a timing graph is built in a manner similar to a GBA implementation. And unlike a GAB simulation that propagates merged delays, a hybrid delay specific timing stage is used to keep and propagate the accurate noise and delay information from different paths and waveforms. The timing graph simplifies the recognition and sharing of logic-identical input and enables stage level parallelism, which is more efficient and more scalable than path level parallelism due to its fine gradient and computational locality.

The basic delay calculation unit in a digital integrated circuit is a stage, which consists of a driving cell, the RC network of the net at the output of the cell, and the capacitive load of the network load pins. A GBA implementation builds a directed graph for the whole circuit and groups cells by their logic levels. At each pin, only the worst slew is kept from all possible fanin paths. As a result, the GBA stage is cell arc specific. Each cell arc will only be calculated once. This enables GBA to maintain high performance but lose path-specific accuracy. At each logic level, stage delays are independent to each other and can be calculated in parallel.

On the other hand, since the worst slew at each pin is too pessimistic, a PBA implementation analyzes the design by path. At each pin in each path, the path specific slew is used, thereby reducing pessimism. However, since the number of paths is increasing exponentially with the number of cells, and it is difficult for a path-based analysis to identify slews shared by different paths, such an implementation is a magnitude slower than a GBA implementation. The parallelism is also path-based, which is less efficient than a stage-based implementation.

Stage delays rely not only on the input slew, but also on the supply voltage, which is dynamically changing based on the signal arrival time and noise waveform. Therefore, the different inputs may not be merged as in GBA. The hybrid stage is delay-specific. At each pin, if a delay is associated with different fanout paths but is coming from the same fanin path, it will be kept as one delay. If multiple delays and voltage noises are similar at each pin, they can be compressed.

Each stage delay calculation includes two major computation components—RC network reduction and CCS library-based simulation. Each net RC network build and reduction is design-specific, and cannot be pre-characterized like a CCS library. It is common for a net RC network to have thousands of nodes and many loops. An RC network build and reduction computation time can be twice the computation time of a CCS-library based simulation. And unlike a CCS library-based simulation, an RC network is independent of cell input slew and supply voltage. Therefore, for all the different input delay and supply voltage of a cell, the RC network may be calculated only once and may be reused by all scenarios. This results in a significant performance increase.

When performing timing analysis, loading a full detailed SPEF file usually takes the largest portion of memory of the entire workflow. Normally the majority of the SPEF information is kept at a disk or slower storage, and only the nets that are currently being analyzed will be loaded into memory. For path-based parallelism, when a net is included in multiple paths, its RC information will be cached between the file and memory multiple times for different path analysis. A lock is also necessary to prevent the risk of data race in parallelism. This becomes a bottleneck for scalability and performance. In the hybrid GBA-PBA implementation, parallelism is performed for stages in the same logic level, where each net's RC network is only loaded and used once for all scenarios, and is then discarded once this stage has completed. This implementation results in highly efficient memory usage and high performance, and is highly scalable without using locks.

### Exemplary Architecture

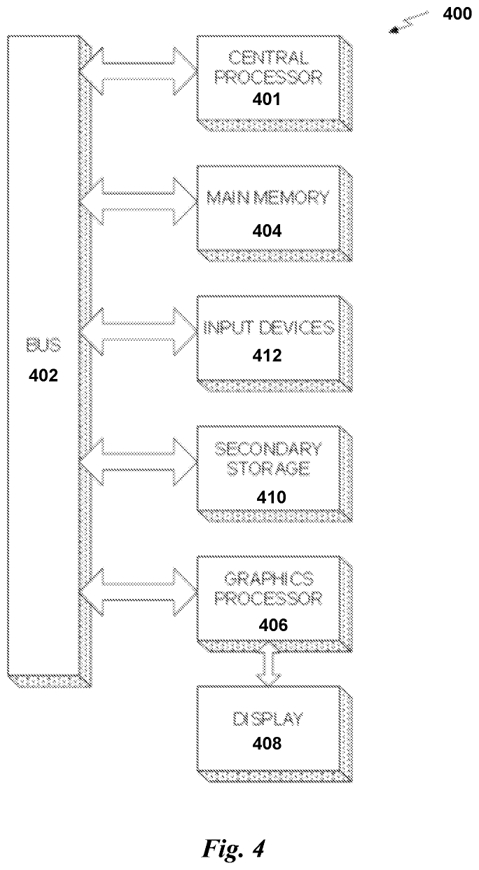

FIG. 4 illustrates an exemplary system 400 in which the various architecture and/or functionality of the various previous embodiments may be implemented. As shown, a system 400 is provided including at least one central processor 401 that is connected to a communication bus 402. The communication bus 402 may be implemented using any suitable protocol, such as PCI (Peripheral Component Interconnect), PCI-Express, AGP (Accelerated Graphics Port), HyperTransport, or any other bus or point-to-point communication protocol(s). The system 400 also includes a main memory 404. Control logic (software) and data are stored in the main memory 404 which may take the form of random access memory (RAM).

The system 400 also includes input devices 412, a graphics processor 406, and at least one display 408, i.e. a conventional CRT (cathode ray tube), LCD (liquid crystal display), LED (light emitting diode), plasma display or the like. User input may be received from the input devices 412, e.g., keyboard, mouse, touchpad, microphone, and the like. In one embodiment, the graphics processor 406 may include a plurality of shader modules, a rasterization module, etc. Each of the foregoing modules may even be situated on a single semiconductor platform to form a graphics processing unit (GPU).

In the present description, a single semiconductor platform may refer to a sole unitary semiconductor-based integrated circuit or chip. It should be noted that the term single semiconductor platform may also refer to multi-chip modules with increased connectivity which simulate on-chip operation, and make substantial improvements over utilizing a conventional central processing unit (CPU) and bus implementation. Of course, the various modules may also be situated separately or in various combinations of semiconductor platforms per the desires of the user.

The system 400 may also include a secondary storage 410. The secondary storage 410 includes, for example, a hard disk drive and/or a removable storage drive, representing a floppy disk drive, a magnetic tape drive, a compact disk drive, digital versatile disk (DVD) drive, recording device, universal serial bus (USB) flash memory, solid state drive (SSD), etc. The removable storage drive reads from and/or writes to a removable storage unit in a well-known manner.

Computer programs, or computer control logic algorithms, may be stored in the main memory 404 and/or the secondary storage 410. Such computer programs, when executed, enable the system 400 to perform various functions. The memory 404, the storage 410, and/or any other storage are possible examples of computer-readable media.

In one embodiment, the architecture and/or functionality of the various previous figures may be implemented in the context of the central processor 401, the graphics processor 406, an integrated circuit (not shown) that is capable of at least a portion of the capabilities of both the central processor 401 and the graphics processor 406, a chipset (i.e., a group of integrated circuits designed to work and sold as a unit for performing related functions, etc.), and/or any other integrated circuit for that matter. Further still, the circuit may be realized in reconfigurable logic. In one embodiment, the circuit may be realized using an FPGA (field gate programmable array).

Still yet, the architecture and/or functionality of the various previous figures may be implemented in the context of a general computer system, a circuit board system, a game console system dedicated for entertainment purposes, an application-specific system, and/or any other desired system. For example, the system 400 may take the form of a desktop computer, laptop computer, server, workstation, game consoles, embedded system, and/or any other type of logic. Still yet, the system 400 may take the form of various other devices including, but not limited to a personal digital assistant (PDA) device, a mobile phone device, a television, etc.

Further, while not shown, the system 400 may be coupled to a network (e.g., a telecommunications network, local area network (LAN), wireless network, wide area network (WAN) such as the Internet, peer-to-peer network, cable network, or the like) for communication purposes.

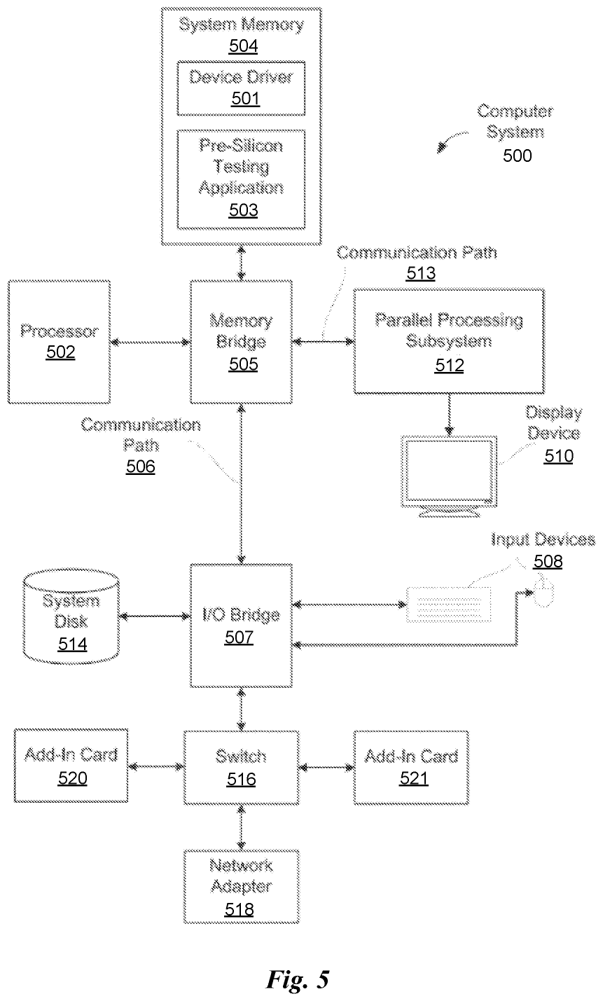

FIG. 5 is a block diagram illustrating a computer system 500 configured to implement one or more aspects of the various embodiments. As shown, computer system 500 includes, without limitation, a processor 502 and a system memory 504 coupled to a parallel processing subsystem 512 via a memory bridge 505 and a communication path 513. Memory bridge 505 is further coupled to an I/O (input/output) bridge 507 via a communication path 506, and I/O bridge 507 is, in turn, coupled to a switch 516.

In general, processor 502 may retrieve and execute programming instructions stored in system memory 504. Processor 502 may be any technically feasible form of processing device configured to process data and execute program code. Processor 502 could be, for example, a central processing unit (CPU), a graphics processing unit (GPU), an application-specific integrated circuit (ASIC), a field-programmable gate array (FPGA), and so forth. Processor 502 stores and retrieves application data residing in the system memory 504. Processor 502 is included to be representative of a single CPU, multiple CPUs, a single CPU having multiple processing cores, and the like. In operation, processor 502 is the master processor of a mobile device, controlling and coordinating operations of other system components. System memory 504 stores software application programs and data for use by processor 502. Processor 502 executes software application programs stored within system memory 504 and optionally an operating system. In particular, processor 502 executes software and then performs one or more of the functions and operations set forth in the present application.

In operation, I/O bridge 507 is configured to receive user input information from input devices 508, such as a keyboard or a mouse, and forward the input information to processor 502 for processing via communication path 506 and memory bridge 505. Switch 516 is configured to provide connections between I/O bridge 507 and other components of the computer system 500, such as a network adapter 518 and various add-in cards 520 and 521.

As also shown, I/O bridge 507 is coupled to a system disk 514 that may be configured to store content and applications and data for use by processor 502 and parallel processing subsystem 512. As a general matter, system disk 514 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 507 as well.

In various embodiments, memory bridge 505 may be a Northbridge chip, and I/O bridge 507 may be a Southbridge chip. In addition, communication paths 506 and 513, as well as other communication paths within computer system 500, may be implemented using any technically suitable protocols, including, without limitation, AGP (Accelerated Graphics Port), HyperTransport, or any other bus or point-to-point communication protocol known in the art.

In some embodiments, parallel processing subsystem 512 is part of a graphics subsystem that delivers pixels to a display device 510 that may be any conventional cathode ray tube, liquid crystal display, light-emitting diode display, or the like. In such embodiments, the parallel processing subsystem 512 incorporates circuitry optimized for graphics and video processing, including, for example, video output circuitry. Such circuitry may be incorporated across one or more parallel processing units (PPUs) included within parallel processing subsystem 512. In other embodiments, the parallel processing subsystem 512 incorporates circuitry optimized for general purpose and/or compute processing. Again, such circuitry may be incorporated across one or more PPUs included within parallel processing subsystem 512 that are configured to perform such general purpose and/or compute operations. In yet other embodiments, the one or more PPUs included within parallel processing subsystem 512 may be configured to perform graphics processing, general purpose processing, and compute processing operations.

The system memory 504 may include, without limitation, at least one device driver 501 configured to manage the processing operations of the one or more PPUs within parallel processing subsystem 512. The system memory 504 may further include, without limitation, a pre-silicon testing application 503. Processor 502 executes the pre-silicon testing application 503 to perform one or more of the techniques disclosed herein and to store data in and retrieve data from system memory 504.

As further described herein, the pre-silicon testing application 503 performs a voltage simulation followed by voltage aware timing analysis of an integrated circuit design. The pre-silicon testing application 503 performs a dynamic analysis of the integrated circuit design to determine the delay through each circuit path in the integrated circuit design. In so doing, the pre-silicon testing application 503 applies a voltage waveform to the input of each path in the integrated circuit, then propagates the input voltage waveform together with the input signal waveform in order to dynamically determine the voltage waveform at each gate in each path.

The pre-silicon testing application 503 determines a voltage at each gate based on one or more voltage waveforms. The voltage waveforms may include a supply voltage waveform, a ground signal waveform, and an input voltage waveform, in any technically feasible combination.

The pre-silicon testing application 503 performs a graph-based and path-based hybrid timing simulation based on the netlists, including temporal and spatial information of the integrated circuit design. In so doing, the pre-silicon testing application 503 selects either a fixed-frequency clock generator or a noise-adaptive clock generator in order to compute timing margins based on the relevant clock source.

If the integrated circuit design includes a fixed-frequency clock generator, then the pre-silicon testing application 503 applies a model of a fixed-frequency clock to the netlists. The clock output of the fixed-frequency clock generator operates at a fixed frequency. The pre-silicon testing application 503 determines the clock cycle duration of the fixed frequency. The pre-silicon testing application 503 determines slack times based on a difference between the clock cycle duration of the fixed frequency and a path delay of the netlists. The slack times determined by the pre-silicon testing application 503 correspond to slack values as the voltage varies over time.

If the integrated circuit design includes a noise-adaptive clock generator, then the pre-silicon testing application 503 applies a model of a noise-adaptive clock to the netlists. The clock output of the noise-adaptive clock generator operates at a frequency that varies with changes in the supply voltage. The pre-silicon testing application 503 determines the clock output frequency based on the value of the supply voltage. The pre-silicon testing application 503 determines the clock cycle duration of the clock output frequency. The pre-silicon testing application 503 determines slack times based on a difference between the clock cycle duration of the clock output frequency and a path delay of the netlists. When the supply voltage changes from a first value to a second value, the pre-silicon testing application 503 determines the new clock output frequency based on the second value of the supply voltage and repeats the process set forth above.

The pre-silicon testing application 503 performs the timing analysis on the netlists to determine a set of slack times that correspond to a set of voltages applied to the integrated circuit. The pre-silicon testing application 503 produces an ordered list of critical paths. In so doing, the pre-silicon testing application 503 determines, based on the set of slack times, the critical path that has the lowest slack time relative to all other critical paths. In this manner, the ordered list identifies the circuit paths most likely to be the limiting performance factors for the integrated circuit.

In various embodiments, parallel processing subsystem 512 may be integrated with one or more other the other elements of FIG. 5 to form a single system. For example, parallel processing subsystem 512 may be integrated with processor 502 and other connection circuitry on a single chip to form a system on chip (SoC).

It will be appreciated that the system shown herein is illustrative and that variations and modifications are possible. The connection topology, including the number and arrangement of bridges, the number of processors 502, and the number of parallel processing subsystems 512, may be modified as desired. For example, in some embodiments, system memory 504 could be connected to processor 502 directly rather than through memory bridge 505, and other devices would communicate with system memory 504 via memory bridge 505 and processor 502. In other alternative topologies, parallel processing subsystem 512 may be connected to I/O bridge 507 or directly to processor 502, rather than to memory bridge 505. In still other embodiments, I/O bridge 507 and memory bridge 505 may be integrated into a single chip instead of existing as one or more discrete devices. Lastly, in certain embodiments, one or more components shown in FIG. 5 may not be present. For example, switch 516 could be eliminated, and network adapter 518 and add-in cards 520, 521 would connect directly to I/O bridge 507.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including handheld devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A method comprising, at a device:
determining a timing of a circuit design,
wherein a voltage noise model is utilized when determining the timing.

2. The method of claim 1, wherein an adaptive clock model is also utilized when determining the timing.

3. The method of claim 1, wherein during each clock cycle while determining the timing of the circuit design:
a previous cycle supply noise is identified, and
the previous cycle supply noise is used to dynamically determine a period of the clock cycle and to determine a clock cycle start time at a clock generator root pin of the circuit design.

4. The method of claim 1, wherein the voltage noise model includes original supply noise waveforms for one or more power supplies.

5. The method of claim 4, wherein the original supply noise waveforms are produced by physical voltage supplies.

6. The method of claim 4, wherein the original supply noise waveforms are used instead of a fixed voltage when determining the timing of the circuit design.

7. The method of claim 4, comprising calculating gate delays while determining the timing, where the original supply noise waveforms are checked to determine a real operational voltage of a gate at a time when a signal arrives at a gate input pin of the circuit design.

8. The method of claim 7, comprising:
determining three voltage corners surrounding the real operational voltage utilizing the voltage noise model,
determining gate delays at the voltage corners; and
applying quadratic interpolation to the gate delays to determine a real gate delay for the circuit design at a given voltage.

9. The method of claim 1, comprising adjusting the circuit design based on the determined timing.

10. The method of claim 1, comprising constructing a hardware circuit based on the circuit design.

11. A system comprising:
a hardware processor of a device that is configured to:
determine a timing of a circuit design,
wherein a voltage noise model is utilized when determining the timing.

12. The system of claim 11, wherein the voltage noise model includes original supply noise waveforms for one or more power supplies.

13. A non-transitory computer-readable storage medium storing instructions that, when executed by a processor of a device, causes the processor to cause the device to:
determine a timing of a circuit design,
wherein a voltage noise model is utilized when determining the timing.

14. The computer-readable storage medium of claim 13, wherein the voltage noise model includes original supply noise waveforms for one or more power supplies.

15. A method comprising, at a device:
determining a timing of a circuit design,
wherein both a graph-based approach and a path-based approach are used when determining the timing.

16. The method of claim 15, wherein a hybrid stage including both the graph-based approach and the path-based approach is used to determine the timing of the circuit design.

17. The method of claim 16, wherein the hybrid stage includes a calculation of delay within the circuit design.

18. The method of claim 16, wherein the hybrid stage includes a driving cell, an RC network of a net at an output of the driving cell, a capacitive load of network load pins within the circuit design, and a path, cycle and logic-uniquified input signal.

19. The method of claim 15, wherein utilizing the graph-based approach, a directed acyclic graph (DAG) is constructed for the circuit design, where the DAG represents all paths within the circuit design.

20. The method of claim 19, wherein during an analysis of the circuit design, each gate in the DAG is visited only once.

21. The method of claim 19, wherein utilizing the path-based approach, all delay calculations from all paths and cycles within the circuit design that are related to a gate are performed during a single visit to the gate and are propagated throughout the rest of the circuit design.

22. The method of claim 16, wherein the hybrid stage simulates the circuit design, and the simulation is divided into an input-dependent portion and an input-independent portion,
where the input-independent portion is calculated once for all possible scenarios within the circuit design.

23. The method of claim 19, wherein logic-identical input delays are shared among different paths during a testing of the circuit design.

24. The method of claim 19, wherein delay and noise values that are identical or have a difference within a predetermined threshold value are shared among different paths, waveforms, and scenarios within the circuit design.

25. A system comprising:
a hardware processor of a device that is configured to:
determine a timing of a circuit design,
wherein both a graph-based approach and a path-based approach are used when determining the timing.

26. The system of claim 25, wherein utilizing the graph-based approach, a directed acyclic graph (DAG) is constructed for the circuit design, where the DAG represents all paths within the circuit design.

27. A non-transitory computer-readable storage medium storing instructions that, when executed by a processor of a device, causes the processor to cause the device to:
determine a timing of a circuit design,
wherein both a graph-based approach and a path-based approach are used when determining the timing.

28. The computer-readable storage medium of claim 27, wherein utilizing the graph-based approach, a directed acyclic graph (DAG) is constructed for the circuit design, where the DAG represents all paths within the circuit design.
